(19) United States
(12) Patent Application Publication
(10) Pub. No.: US 2008/0198704 A1
(43) Pub. Date: Aug. 21, 2008

(54) Methods and Systems for Providing a Moveable Cover for a Timepiece

(75) Inventors: Sherman Anthony Wright, Columbia, SC (US); Sheryl Anita Wright, Columbia, SC (US)

Correspondence Address: SUTHERLAND ASBILL & BRENNAN LLP, 999 PEACHTREE STREET, N.E., ATLANTA, GA, 30309, US

(73) Assignee: Shermone Vermelle LLC, Columbia, SC (US)

(21) Appl. No.: 12/112,302

(22) Filed: Apr. 30, 2008

Related U.S. Application Data
(63) Continuation of application No. 11/444,854, filed on May 31, 2006, now abandoned.
(60) Provisional application No. 60/686,577, filed on May 31, 2005.

(51) Int. Cl. G04B 37/18; G04B 37/00

(52) U.S. Cl. 368/281; 368/309

(57) ABSTRACT

Embodiments of the invention can provide systems and methods for providing a moveable cover for a timepiece. In one embodiment, a timepiece includes a housing with a display face capable of displaying a time. The timepiece can also include a plurality of covers each capable of covering a portion of the display face, wherein each cover is moveable between an open and a closed position, and wherein the display face can be viewed when the covers are in an open position and the display face can be covered when the covers are in a closed position. Furthermore, the timepiece can include a control device capable of manipulating the plurality of covers between the open and closed positions.

### CROSS-REFERENCE TO RELATED APPLICATIONS

This application is a continuation of co-pending U.S. patent application Ser. No. 11/444,854, entitled “Methods and Systems for Providing A Moveable Cover for a Timepiece,” filed May 31, 2006, which claims priority to U.S. Provisional Application Ser. No. 60/686,577, entitled “Methods and Systems for Providing a Pressure Activated Cover for a Timepiece,” filed May 31, 2005, which are incorporated herein by reference in their entirety.

### FIELD OF THE INVENTION

This invention generally relates to timepieces. More particularly, the invention relates to methods and systems for providing a moveable cover for a timepiece.

### BACKGROUND

Protective coverings for timepieces have been used to protect various timepiece components, such as the watch face or crystal. However, these conventional protective coverings, in some instances, require manual operation. In other instances, such protective coverings are bulky and cumbersome, and are not particularly attractive for relatively expensive timepieces.

One type of wristwatch of substantially rectangular shape includes two sliding shutter-type covers that slide over the watch face to show or to conceal the face. Movement of the sliding covers requires manual action. The shutters are secured to the case by at least two cylindrical pins whose ends emerge on either side of a listel secured to the timepiece and are engaged in grooves located on either side of the listel. The shutters are guided into closed and open positions by two rails that emerge from the timepiece and are engaged in grooves in the shutters.

Another type of watch includes a cover lid. In one form of the structure for preventing inadvertent opening of a cover lid of a water-proof watch, a protrusion formed on the cover lid is locked into a recess formed at a head of a lock button. A coil spring is attached to the lock button to bias the same to maintain the engagement between the recess of the lock button and the protrusion of the cover lid so as to prevent inadvertent opening or unlocking of the cover lid.

However, these and other conventional protective coverings and cover lids can require a user to manually operate the protective covering or cover lid. Manual operations associated with operating these coverings or lids, such as a sliding the protective covering or pivoting a cover lid, can require particularly fine or precise movements by a user.

Accordingly, there is a need for improved methods and systems for providing a moveable cover for a timepiece.

### SUMMARY OF THE INVENTION

Some or all of the above needs can be addressed by various embodiments of the present invention. Embodiments of the invention can include methods and systems for providing a moveable cover for a timepiece. One aspect of one embodiment can include a system for automatically opening and closing a cover for a timepiece.

Another aspect of one embodiment can include a system for opening and closing covers for a timepiece, wherein the covers include one or more leaves. Such leaves can be positioned over a display face and within a housing for the timepiece. In another aspect of one embodiment, the covers can comprise at least two independent covers, which are initially positioned opposite each other on opposing sides of a face for the timepiece. In yet another embodiment, the cover can comprise one cover which is initially positioned on one side of a face for the timepiece. The leaves or covers can be manipulated by a control device, such as a combination of a pinion, ring gear, drive gear, and motor. When the motor is activated, by applying a manual force or pressure to a switch or crown, the motor can rotate the drive gear and turn the ring gear and pinion. This action can move the leaves or covers from an open to a closed position, and vice versa. The motor and movement of the covers can be powered by an internal rechargeable battery.

Yet another aspect of one embodiment can include a system for opening and closing covers for a timepiece using one or more pressure switches. When the pressure switches are activated, by applying a manual force or pressure to the covers, the pressure switches can activate the opening of the covers. The pressure switches and movement of the covers can be powered by an internal rechargeable battery.

In another aspect of the embodiment, the moveable covers or leaves can include ornamentation such as at least one precious gem, an etching, an ornamental design, a logo, an emblem, a series of alphanumeric characters, or a color.

In one aspect of the embodiment, the covers can be manufactured from glass, plastic, a clear material, stainless steel, silver or gold, and can include a variety of etchings including drawings and script.

In one aspect of an embodiment, a timepiece includes a housing with a display face capable of displaying a time. The timepiece can also include a number of covers capable of covering a portion of the display face. Each cover is moveable between an open and a closed position, so that some or all of the display face can be viewed when the covers are in an open position and some or all of the display face can be covered when the covers are in a closed position. Furthermore, the timepiece can include a control device capable of manipulating the plurality of covers between an open and closed position.

In one aspect of the embodiment, each cover may be made from a relatively clear material, and some or all of the display face may be viewed through the covers when in either an open or closed positions.

In another aspect of the embodiment, each cover may be made from a relatively opaque material, and some or all of the display face may be hidden from view when the covers are in a closed position.

Another aspect of one embodiment can include a method of operating a timepiece with moveable covers. The method includes providing a timepiece comprising a housing, a display face capable of displaying a time, and a plurality of covers within the housing, wherein each cover is moveable between an open and a closed position, wherein a portion of the display face can be viewed when the covers are in an open position and a portion of the display face is covered when the covers are in a closed position. The method also includes a control device capable of manipulating the plurality of covers between an open and closed position. Furthermore, the method includes activating the control device, wherein the plurality of covers move between a closed position, wherein a portion of the display face can be covered, and an open position, wherein a portion of the display face can be viewed. The method also includes when the plurality of covers is in an open position, viewing the display face to obtain the time.

In one aspect of the embodiment, each cover may be made from a relatively clear material, and some or all of the display face may be viewed through the covers when in either an open or closed positions.

In another aspect of the embodiment, each cover may be made from a relatively opaque material, and some or all of the display face may be hidden from view when the covers are in a closed position.

These exemplary embodiments are mentioned not to limit or define the invention, but to provide examples of embodiments of the invention to aid understanding thereof. Exemplary embodiments are discussed in the Detailed Description, and further description of the invention is provided there. Advantages offered by the various embodiments of the invention may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 illustrates an example environment for a moveable cover for a watch in accordance with an embodiment of the invention.

FIG. 2 illustrates a perspective view of an embodiment of a movable cover for a watch.

FIG. 3 illustrates an overhead assembly view of the embodiment shown in FIG. 2.

FIG. 4 illustrates an exploded perspective view of the embodiment shown in FIGS. 2 and 3.

FIG. 5 illustrates an exploded side view of the embodiment shown in FIGS. 2-4.

FIG. 6 illustrates a side assembly view of the embodiment shown in FIGS. 2-5.

FIG. 7 shows a detail view of the ring gear and drive gear assembly for the embodiment shown in FIGS. 2-6.

FIG. 8 illustrates a flowchart for a method in accordance with an embodiment of the invention.

FIG. 9 illustrates a top plan view of an embodiment of a movable cover for a watch.

FIG. 10 illustrates another view of the embodiment shown in FIG. 9.

### DETAILED DESCRIPTION

Embodiments of the present invention can comprise methods and systems for providing a moveable cover for a timepiece. In one exemplary embodiment of the present invention, a series of moveable covers such as leaves can be positioned to cover a portion of a display face for a timepiece. In a closed position, the covers shield or otherwise hide the display face of the timepiece. In an open position, the moveable covers or leaves can be positioned for a user to view some or all of the display face of the timepiece. In at least one embodiment, each cover or leaf may be made from a relatively clear material, and some or all of the display face may be viewed through the covers when in either an open or closed positions. In another embodiment, each cover may be made from a relatively opaque material, and some or all of the display face may be hidden from view when the covers are in a closed position. In any instance, the moveable covers or leaves can be activated by pressing the externally mounted switch or crown adjacent to a housing for the timepiece or surface of any of the covers. An internal control device or apparatus can cause the moveable covers or leaves to swing open when the switch or crown is manually pressed or touched. The moveable covers or leaves can then recess fully or partially into the housing of the timepiece.

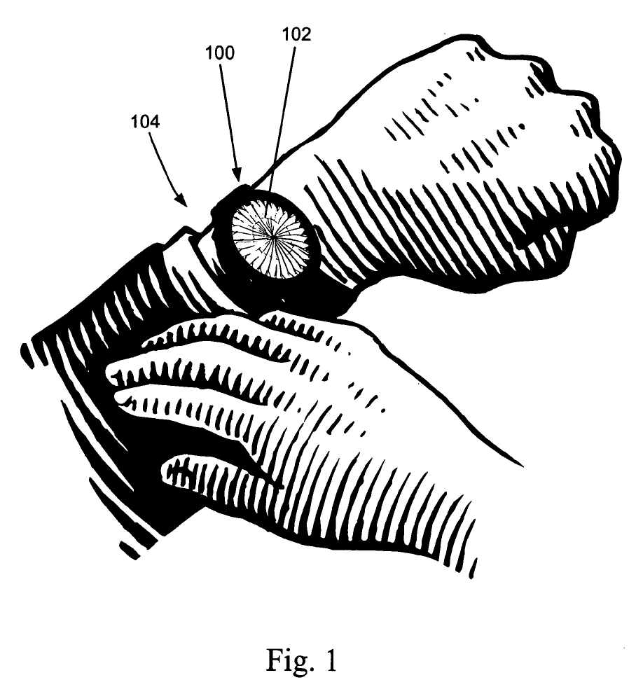

Referring now to the drawings in which like numerals indicate like elements throughout the several figures, FIG. 1 illustrates an example environment for a moveable cover for a watch in accordance with an embodiment of the invention. In this example, a timepiece 100 with moveable covers 102 in accordance with an embodiment of the invention is shown mounted to a portion of a user's body, such as a user's wrist 104. In other embodiments, a timepiece with moveable covers can be a pocket watch, or another timekeeping device.

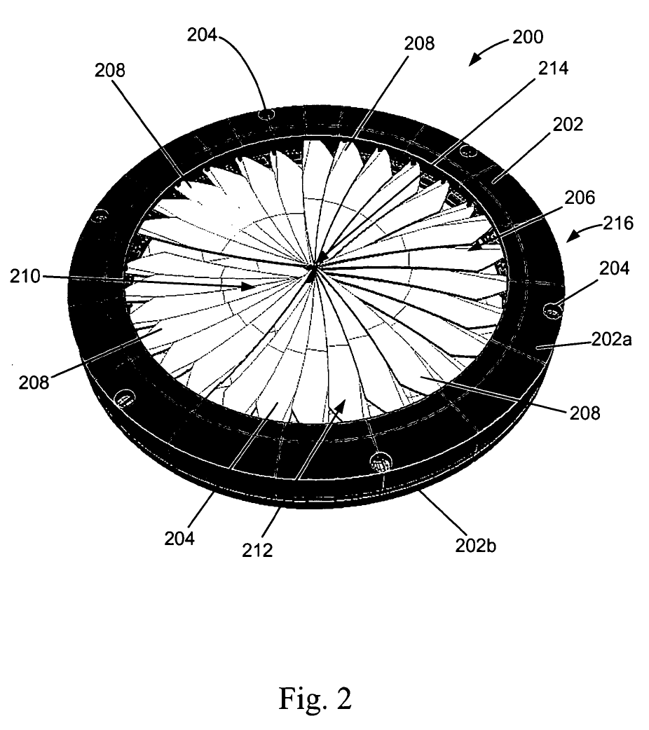

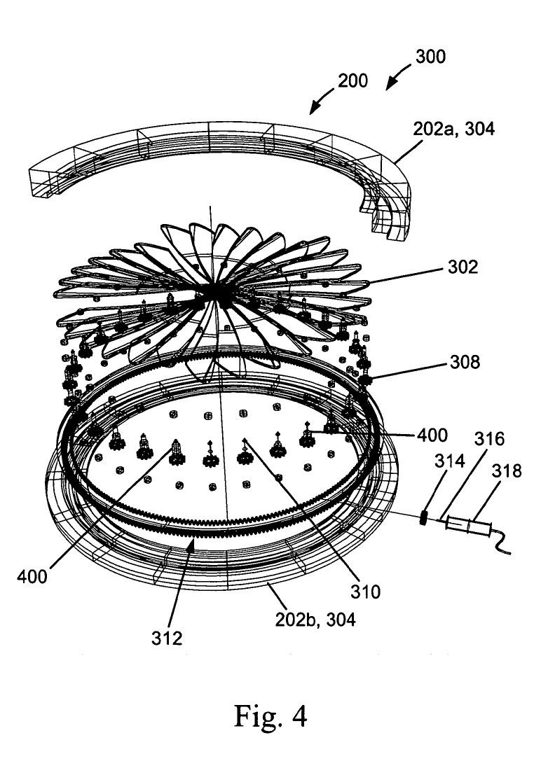

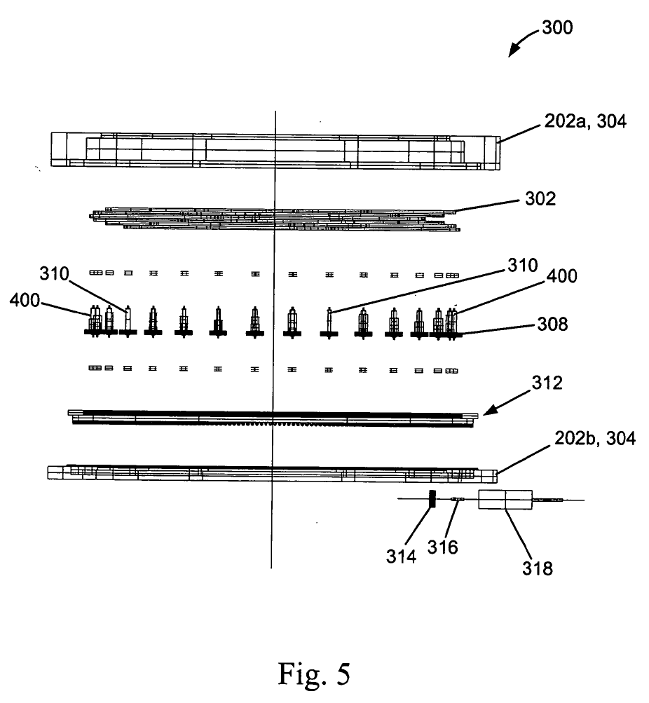

FIG. 2 illustrates a perspective view of an embodiment of a timepiece with movable covers. The example shown in FIG. 2 is a wristwatch-type timepiece 200 with a circular-shaped housing 202 or bezel. In this example, the housing 202 is an upper housing 202a and a lower housing 202b. The upper housing 202a and the lower housing 202b can be mounted together and secured to each other with a series of housing bolts (not shown) or other suitable type connecting devices mounted within corresponding bolt holes 204 machined adjacent to the outer perimeter of the housing 202. The housing 202, including the upper housing 202a and lower housing 202b, is shown in greater detail in FIGS. 4 and 5.

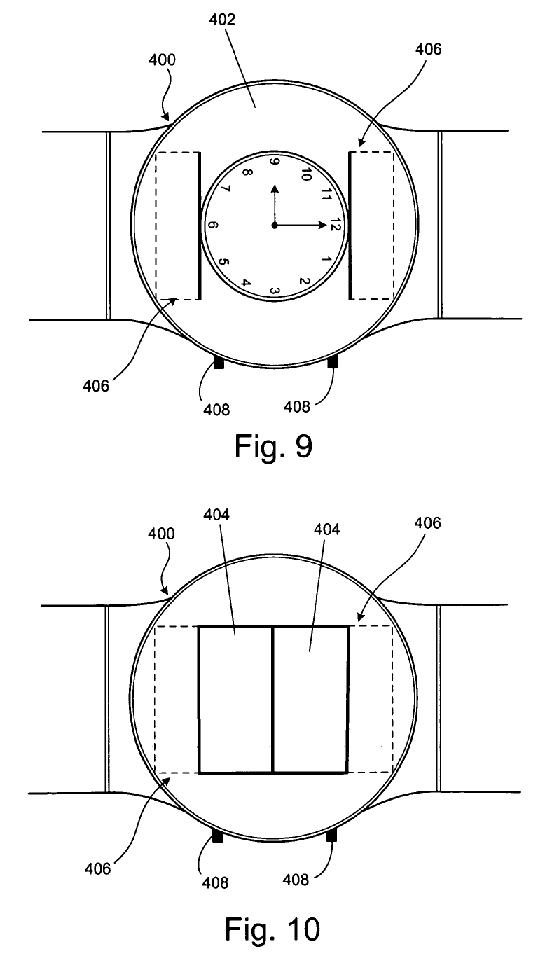

A series of moveable covers 206 positioned within the housing 202 can be manipulated from a relatively open position to a relatively closed position, and vice versa. The moveable covers 206 in FIG. 2 are shown in a relatively closed position. In this example, the moveable covers 206 are a series of about thirty radially extending leaves 208 with a relatively slim portion 210 and a wider portion 212. Each leaf 208 extends from a central portion 214 of the timepiece 200 towards an outer portion 216 of the housing 202, with the relatively thin portion 210 of each leaf adjacent to the central portion 214 of the timepiece 200 and the wider portion 212 of each leaf 208 closer to the outer portion 216 of the housing 202. In other embodiments, leaves for moveable covers can have different configurations, shapes, and sizes, and there may be fewer or greater numbers of leaves than shown in this example. In other embodiments, moveable covers can have different configurations, shapes, and sizes in accordance with the invention. For example, the embodiment shown in FIGS. 9-10 shows a watch with two opposed moveable covers, to be discussed in detail later.

For purposes of ornamentation, some or all of the moveable covers 206 or leaves 208 can include at least one precious gem, an etching, an ornamental design, a logo, an emblem, a series of alphanumeric characters, or a color. In one embodiment, a portion of an etching, an ornamental design, a logo, an emblem, a series of alphanumeric characters, or a color can be affixed to each moveable cover 206 or leaf 208, and thus collectively, the etching, ornamental design, logo, emblem, series of alphanumeric characters, or color can be displayed when some or all of the moveable covers 206 or leaves 208 are in a relatively closed position covering the display face of the timepiece 200. In another embodiment, the moveable covers 206 or leaves 208 can be made from glass, plastic, a clear material, stainless steel, silver, gold, or another precious metal.

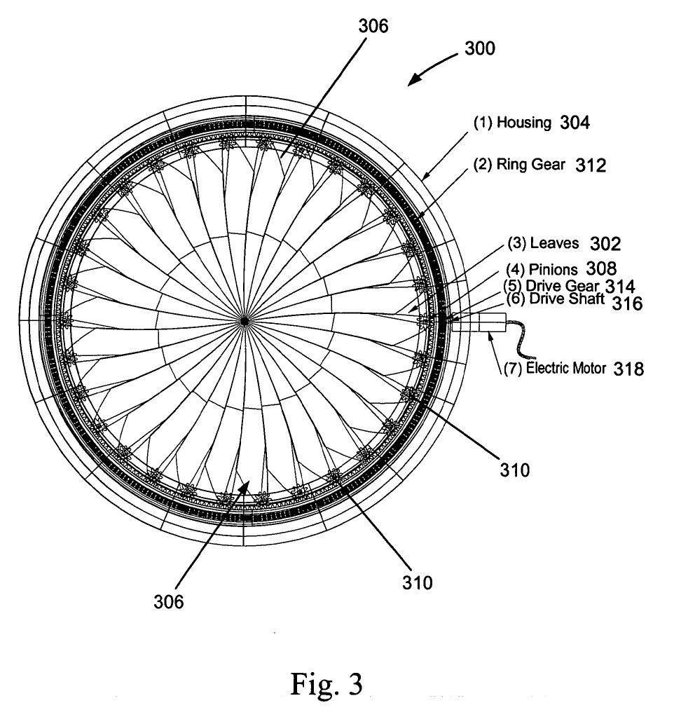

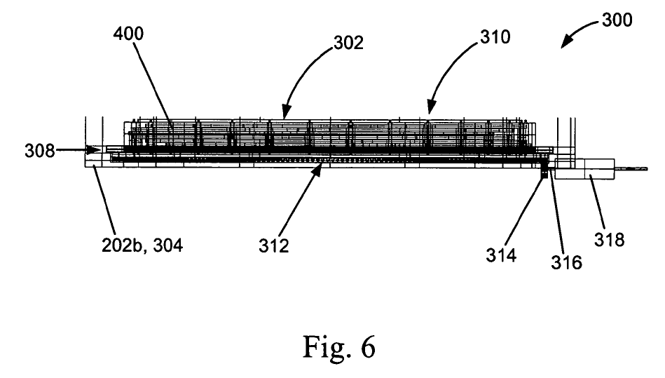

FIG. 3 illustrates an overhead assembly view of the embodiment shown in FIG. 2, and FIG. 6 shows a side assembly view of the embodiment. In this example, the timepiece 300 and moveable covers 302 are shown with component parts permitting the moveable covers 302 to move relative to the housing 304 and display face 306. The display face 306 refers to an upper portion of an adjacent timekeeping device positioned adjacent to the lower housing 202b and beneath the moveable covers 302. Portions of an example timekeeping device may not be shown in the figures, but a suitable timekeeping device and display face can be provided by a conventional analog or digital watch.

The moveable covers 302, or leaves in this example, can be moved from a relatively flat or horizontal position covering the display face 306 to a position adjacent to the outer portion of the housing 304 to permit a user to view the display face 306. Each of the moveable covers 302 or leaves can be associated with a control device or other apparatus capable of manipulating the moveable covers or leaves between an open and closed position, and vice-versa. In this example, the relatively narrow portions of the moveable covers 302 or leaves rotate from the central portion of the display face towards the outer portion of the housing 304. Collectively, the moveable covers 302 or leaves move in a spiral-like movement from a closed to an open position, and vice-versa. In a relatively open position, the moveable covers 302 or leaves move into a recess formed between the upper housing 202a and the lower housing 202b, shown in FIG. 2. In other embodiments, different cover or leaf movement can be implemented, and the above embodiment is provided by way of example.

In the embodiment shown, a control device can be a combination of a series opinions 308 and mounts 310, a ring gear 312, a drive gear 314, a drive shaft 316, a motor 318, and a crown or switch (not shown) capable of activating the motor 318. Each of the moveable covers 302 or leaves can be associated with a respective pinion 308 and mount 310. Each mount 310 maintains the position of a respective pinion 308 with respect to the housing 304. By way of example, the mounts 310 can be mounted to a portion of the lower housing 202b. Each of the associated mounts 310, shown in greater detail in FIGS. 4-6, can include a spacer, shown as 400 in FIG. 4. Each spacer 400 is capable of maintaining a predefined distance between the respective pinion and a corresponding moveable cover 302 or leaf. As shown in FIGS. 3-6, the pinions, mounts, and spacers are arranged in a circular-shaped pattern surrounding the central portion of the display face 306 and adjacent to the perimeter of the display face 306. Furthermore, each space r400 can vary in height with respect to the adjacent spacer 400. The difference in heights between adjacent spacers 400 can be observed in FIGS. 5 and 6. In this manner, two adjacent moveable covers or leaves can be spaced at different distances away from the display face 306 and from the respective corresponding pinions 308.

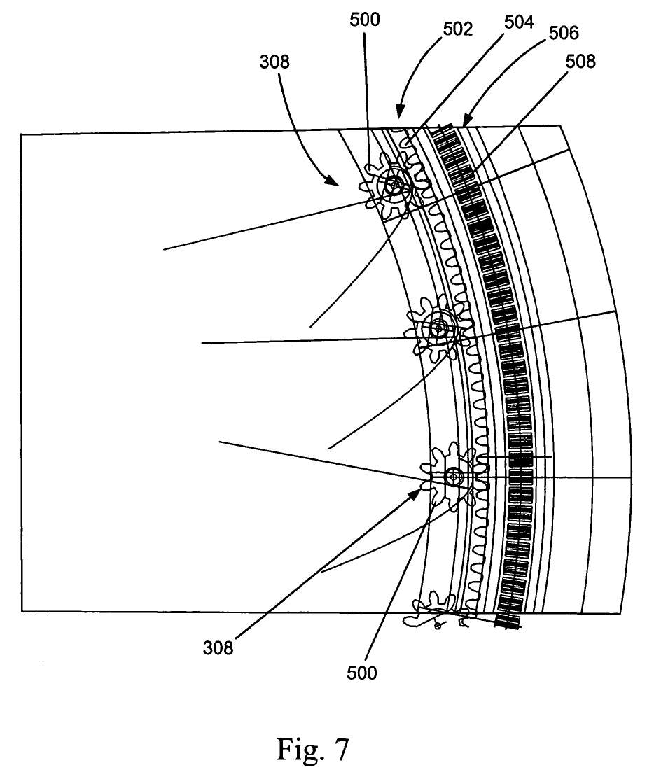

The ring gear 312, a drive gear 314, a drive shaft 316, a motor 318, and a switch provide functionality to rotate the pinions 308, thereby causing the moveable covers 302 or leaves to rotate between an open and a closed position. The ring gear 312 can include a series of ring-shaped gears or components capable of translating a rotational force from the drive gear 314. The drive gear 314 can mount to the drive shaft 316, and is capable of translating force from the drive shaft 316 to the ring gear 312 or associated ring gear components. The motor 318 and associated drive shaft 316 can connect to an electrical power source, such as a battery (not shown). In one embodiment, the battery can be a rechargeable battery capable of receiving a recharging current from an external source, such as a recharger. When the motor 318 is activated by the switch (not shown), the motor 318 can convert an electrical current from the battery and generate a rotational force on the drive shaft 316. As explained above, the rotation of the drive shaft 316 ultimately turns the drive gear 314, which turns the ring gear 312, which turns the pinions 308, and therefore the moveable covers 302 or leaves. A detailed view of the interaction between the pinions 308 and the ring gear 312 or associated ring gear components is shown in FIG. 7.

In other embodiments, different control devices and apparatuses can be used to manipulate or otherwise move the covers or leaves. The above embodiment is provided by way of example.

FIG. 4 illustrates an exploded perspective view of the embodiment shown in FIGS. 2 and 3. The housing 202 is designed to accommodate the various components of the timepiece 300. As explained above, portions of the timekeeping device may not be shown in these figures, however, any suitable timekeeping device such as an analog or digital timekeeping device with a display face can be implemented with the timepiece 300 in accordance with an embodiment of the invention. In one embodiment, a timekeeping device such as a quartz analog movement watch with a display face can be mounted to the lower housing 202b, or can be incorporated between the upper housing 202a and lower housing 202b, such that the display face of the watch or timekeeping device is below the moveable covers 302 or leaves, and can be viewed by a user when the moveable covers 302 or leaves are in an open position.

FIG. 7 shows a detail view of the ring gear and drive gear assembly for the embodiment shown in FIGS. 2-6. The pinions 308 shown in FIG. 7 include a series of pinion teeth 500. The ring gear includes an inner ring gear 502 with a series of inner teeth 504 sized to mesh with the pinion teeth 500. An outer ring gear 506 associated with the ring gear 312 includes a series of outer teeth 508 sized to mesh with the drive gear 314 shown in FIGS. 3-6. When the drive gear 314 is rotated by the motor and driveshaft, the outer ring gear 506 rotates. The movement of the outer ring gear 506 causes the associated inner ring gear 502 to rotate. The rotation of the inner ring gear 502 causes the pinions 308 to turn, thereby rotating the moveable covers 302 or leaves between an open position and a closed position, and vice-versa.

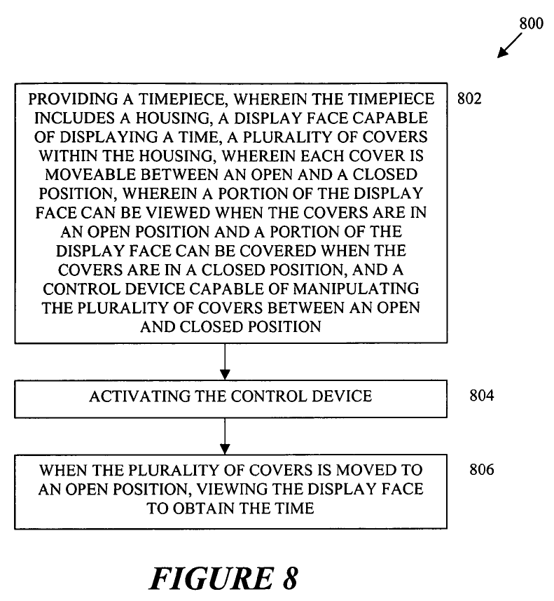

FIG. 8 illustrates a method of operating a timepiece with moveable covers. The method 800 shown can be implemented with a timepiece described in FIGS. 1-7. Other embodiments of a method 800 can have fewer or greater numbers of steps, and the steps provided herein are provided by way of example.

The method 800 begins at block 802. In block 802, a timepiece is provided. In this example, the timepiece can include a housing, and a display face capable of displaying a time. The timepiece can also include a plurality of covers within the housing, wherein each cover is moveable between an open and a closed position, wherein a portion of the display face can be viewed when the covers are in an open position and a portion of the display face can be covered when the covers are in a closed position. In one embodiment, each cover may be made from a relatively clear material, and some or all of the display face may be viewed through the covers when in either an open or closed positions. In another embodiment, each cover may be made from a relatively opaque material, and some or all of the display face may be hidden from view when the covers are in a closed position. Furthermore, the timepiece can include a control device capable of manipulating the plurality of covers between an open and closed position.

Block 802 is followed by block 804, in which the control device is activated. In this example, a user can manipulate a switch or crown as described in FIG. 3. When activated, the plurality of covers can move between a closed position, wherein a portion of the display face can be covered, and an open position, and wherein a portion of the display face can be viewed. In one embodiment, each cover may be made from a relatively clear material, and some or all of the display face may be viewed through the covers when in either an open or closed positions. In another aspect of the embodiment, each cover may be made from a relatively opaque material, and some or all of the display face may be hidden from view when the covers are in a closed position.

Block 804 is followed by block 806, in which the display face is viewed to obtain the time. In this example, when the plurality of covers is moved to an open position, the display face can be viewed by a user, and the user can obtain the time from the display face.

In block 806, the method 800 ends.

FIGS. 9-10 illustrate a top plan view of another embodiment of a timepiece with movable covers. The example shown in FIG. 9 is a wristwatch-type timepiece 400 with a circular shaped housing 402 or bezel. The timepiece 400 has two independent covers 404, which are initially positioned opposite each other on opposing sides of the timepiece 400. A cover 404 can be positioned within each recessed cover area 406, and an associated pressure switch 408 can be located on the side of the housing 402. FIGS. 9 and 10 show two pressure switches 408, wherein each pressure switch 408 can be activated to move each respective cover 404 between open and closed positions. In other embodiments, only one pressure switch 408 can be provided to move both of the covers 404 between open and closed positions. When the pressure switch 408 is activated, the covers 404 rise out of the recessed cover areas 406 and extend to cover and protect the central timepiece 400. Similarly, the covers 404 can be retracted back and downward into the recessed cover areas 406 when the pressure switch 408 is again activated.

In the embodiment shown in FIGS. 9-10, the covers 404 are square shaped, so that when the covers 404 are in the closed position, the covers 404 extend beyond the face of the timepiece 400. But the current invention also contemplates covers 404 of other shapes. For example, each cover 404 can have the shape of a semi-circle. In this manner, when the covers 404 are in the closed position, the covers 404 are circular and cover the face of the timepiece 400 without extending substantially beyond the face of the timepiece 400.

In other embodiments, there could be only one recessed cover 404 and only one corresponding recessed cover area 406. The single cover 404 could be positioned within the recessed cover area 406, and could rise out of the recessed cover area 406 when the pressure switch 408 was activated. In this embodiment, the single cover 404 could be square, oval or circular, or a different shape.

While the above description contains many specifics, these specifics should not be construed as limitations on the scope of the invention, but merely as exemplifications of the disclosed embodiments. Furthermore, embodiments of the invention should not be limited to timepieces, and can be implemented with a variety of other devices, apparatuses, or systems, including, but not limited to, toys, lens, or any device with a display. Those skilled in the art will envision many other possible variations that are within the scope of the invention.

At least the following is claimed:

1. A timepiece comprising:
a housing with a display face capable of displaying a time;
a plurality of covers each capable of covering a portion of the display face, wherein each cover is moveable between an open and a closed position, wherein the display face can be viewed when the covers are in an open position and the display face can be covered when the covers are in a closed position; and
a control device capable of manipulating the plurality of covers between the open and closed positions.

2. The timepiece of claim 1, wherein the housing comprises at least one of the following: at least one precious gem, an etching, an ornamental design, a logo, an emblem, a series of alphanumeric characters, or a color.

3. The timepiece of claim 1, wherein at least some of the plurality of covers include at least one of the following: a precious gem; at least a portion of an etching, an ornamental design, a logo, or an emblem; an alphanumeric character, or a color.

4. The timepiece of claim 1, wherein the plurality of covers comprises a plurality of radially extended leaves, wherein each of the leaves extends from a central portion of the display face to an outer portion of the housing, and movement of the leaves is controlled by the control device.

5. The timepiece of claim 1, wherein the plurality of covers comprises thirty leaves that cover the display face of the timepiece.

6. The timepiece of claim 1, wherein the plurality of covers comprise glass, plastic, a clear material, stainless steel, silver, gold, or a precious metal.

7. The timepiece of claim 1, wherein the display face is further capable of displaying calendar-type information, a message, or previously stored information.

8. The timepiece of claim 1, wherein when the covers are in the closed position, the display face is hidden from view.

9. The timepiece of claim 1, further comprising a wristband capable of mounting the housing to a user's wrist.

10. A method of operating a timepiece with moveable covers, comprising:
providing a timepiece comprising
a housing;
a display face capable of displaying a time;
a plurality of covers within the housing, wherein each cover is moveable between an open and a closed position, wherein a portion of the display face can be viewed when the covers are in an open position and a portion of the display face can be covered when the covers are in a closed position; and
a control device capable of manipulating the plurality of covers between an open and closed position;
activating the control device, wherein the plurality of covers move between a closed position, wherein a portion of the display face can be covered, and an open position, wherein a portion of the display face can be viewed; and
when the plurality of covers is in an open position, viewing the display face to obtain the time.

11. The method of claim 10, wherein activating the control device comprises manipulating a switch externally mounted to the housing.

12. The method of claim 10, further comprising mounting the timepiece to a portion of a user's body.

13. The method of claim 10, wherein the plurality of covers comprises thirty leaves that cover the display face of the timepiece.

14. The method of claim 10, wherein the housing comprises at least one of the following: at least one precious gem, an etching, an ornamental design, a logo, an emblem, a series of alphanumeric characters, or a color.

15. The method of claim 10, wherein at least some of the plurality of covers comprise at least one of the following: a precious gem; a portion of an etching, an ornamental design, a logo, an emblem, or an alphanumeric character; or a color.

16. The method of claim 10, wherein the plurality of covers comprises a plurality of radically extended leaves, wherein each of the leaves extends from a central portion of the display face to an outer portion of the housing, and movement of the leaves is controlled by the control device.

17. The method of claim 10, wherein the plurality of covers comprises thirty leaves that cover the display face of the timepiece.

18. The method of claim 10, wherein the plurality of covers comprise glass, plastic, a clear material, stainless steel, silver, gold, or a precious metal.

19. The method of claim 10, wherein the display face is further capable of displaying calendar-type information, a message, or stored previously information.

20. The method of claim 10, wherein the timepiece further comprises a wristband capable of mounting the housing to a user's wrist.

21. The method of claim 10, wherein when the covers are in the closed position, the display face is hidden from view.

22. A timepiece comprising:
a band to mount the timepiece to a portion of a user's body;
a housing with a display face capable of displaying a time;
a plurality of covers each capable of covering a portion of the display face, wherein
each cover comprises a leaf moveable between an open and a closed position,
the display face can be viewed when the covers are in an open position and the display face can be covered when the covers are in a closed position; and
a control device capable of manipulating the plurality of covers between an open and closed position.
